(19) United States
(12) Patent Application Publication
(10) Pub. No.: US 2017/0148551 A1
(43) Pub. Date: May 25, 2017

(54) GROMMET

(71) Applicant: HARADA INDUSTRY CO., LTD., Tokyo (JP)

(72) Inventor: Keiichi GAKUHARI, Tokyo (JP)

(21) Appl. No.: 15/355,517

(22) Filed: Nov. 18, 2016

(30) Foreign Application Priority Data
Nov. 25, 2015 (JP) 2015-229878

(51) Int. Cl. H01B 17/58; H02G 3/22

(52) U.S. Cl. CPC H01B 17/583; H02G 3/22

(57) ABSTRACT

A grommet includes (i) a body fitted into a through hole of a housing and (ii) an extension located on one side of the housing with respect to the body and having a part larger in dimensions than the through hole. The extension has an inclined surface, an outer shape of which becomes smaller toward an end on a side opposite to the body. A recess, which is recessed with respect to the inclined surface, is formed on a portion of the inclined surface between a body-near portion and an end-near portion.

### CROSS-REFERENCE TO RELATED APPLICATION

This application claims priority to Japanese Patent Application No. 2015-229878 filed on Nov. 25, 2015, the entire disclosure of which is incorporated by reference herein.

### BACKGROUND

The present disclosure relates to a grommet for automotive vehicles interposed between (i) a housing, or a different kind of container, having a through hole and accommodating a circuit or a different kind of electronic device which needs to be waterproof inside, and (ii) a cable passing through the through hole.

Devices such as an antenna for automotive vehicles and a circuit connected to the antenna are connected via a cable to a radio or a car navigation device. A housing containing the antenna and the circuit has a through hole through which the cable passes. Arranging a grommet between the through hole and the cable reduces the risk of water and dust intruding into the housing. It is conceivable to make the grommet stiffer or to reduce its distance to the through hole to a very tight gap in order to increase the waterproofness of the housing. In this case, however, it becomes difficult to install the grommet in the through hole.

Providing the grommet with a flexible cup portion having an easily reducible diameter to make the grommet easier to install into the through hole is known in the art (see, for example, Japanese Unexamined Patent Publication No. 2001-41359). Forming an inclined portion on an end of the grommet, and forming crests and troughs alternately arranged in a circumferential direction along the inclined portion has been proposed as a technique for reducing contact resistance during the installation of the grommet (see, for example, Japanese Unexamined Patent Publication No. 2015-15869).

### SUMMARY

However, providing the grommet with a flexible cup portion, as in Japanese Unexamined Patent Publication No. 2001-41359, increases the grommet in size and is likely to increase production costs of a mold used to form the grommet.

Moreover, forming crests and troughs alternately arranged in a circumferential direction along an inclined portion of the grommet, as in Japanese Unexamined Patent Publication No. 2015-15869, is likely to require a complicated mold and, eventually, to increase the production costs of the mold.

In view of the foregoing background, the present disclosure provides a grommet improving the waterproofness (hermeticity) of a housing, simplifies the installment of the grommet in the through hole, as well as miniaturizes the grommet, and thus facilitates a reduction in production costs.

### Solution to the Problem

According to a first aspect of the present disclosure,

a grommet interposed between (i) a housing having a through hole and (ii) a cable passing through the through hole includes

a body fitted into the through hole of the housing, and

an extension located on one side of the housing with respect to the body and having a part larger in dimensions than the through hole of the housing, wherein

the extension has an inclined surface, an outer shape of which becomes smaller toward an end on a side opposite to the body, and

a recess, which is recessed with respect to the inclined surface, is formed on a portion of the inclined surface between a body-near portion and an end-near portion.

Forming the recess on the inclined surface of the extension allows a part other than the recess to be easily reduced in size, and makes the grommet easy to insert into the through hole. Moreover, forming the recess on a portion of the inclined surface between the body-near portion and the end-near portion may prevent a part of the end-near portion from being caught in the through hole when the grommet is started to be inserted into the through hole. Further, forming the recess on a portion of the inclined surface between the body-near portion and the end-near portion may allow to increase stiffness near a body-near end portion of the extension and near the end on the side opposite to the body. This allows to securely fix a body-near portion of the extension to a periphery of the through hole after the grommet has been inserted into the through hole. Thus, waterproofness of the housing may be easily increased.

A second aspect of the present disclosure relates to the grommet according to the first aspect of the present disclosure, wherein

the recess includes a surface vertical with respect to a front face of the housing and a surface parallel to the surface of the housing.

This configuration makes the grommet easy to form.

A third aspect of the present disclosure relates to the grommet of the first or the second aspect of the present disclosure, wherein

a cross-sectional shape of the body in a direction parallel to the front face of the housing is defined by a pair of parallel portions and circular arc-shaped portions on two sides, and the recess is only formed on a part of the inclined surface corresponding to the circular arc-shaped portions.

This configuration allows the grommet to be reduced in size in a direction along the pair of parallel portions and thus to be inserted into the through hole of a panel of the housing even easier.

A fourth aspect of the present disclosure relates to the grommet of any one of the first to third aspects of the present disclosure, wherein

a blind hole having a bottom arranged at a lower location than an end face of the body-near end is formed on the end of the extension on the side opposite to the body.

This configuration makes the grommet even easier to reduce in size, and thus even easier to insert into the through hole of a panel member of the housing.

A fifth aspect of the present disclosure relates to the grommet of the fourth aspect of the present disclosure, wherein

a rib is formed on the blind hole to divide the blind hole into regions.

Such a configuration allows the grommet to easily maintain the strength of the end face of the end of the extension on the side opposite to the body.

The present disclosure provides a grommet increasing the waterproofness of a housing, simplifies the installment of the grommet in the through hole, as well as facilitates a reduction in production costs.

### BRIEF DESCRIPTION OF THE DRAWINGS

FIG. 1 is a front view of a configuration of a grommet.

FIG. 2 is a side view of the configuration of the grommet.

FIG. 3 is a cross-sectional view of the grommet along the line in FIG. 1.

FIG. 4 is a plan view of the configuration of the grommet.

FIG. 5 is a bottom view of the configuration of the grommet.

### DETAILED DESCRIPTION

Embodiments of the present disclosure will now be described in detail with reference to the accompanying drawings.

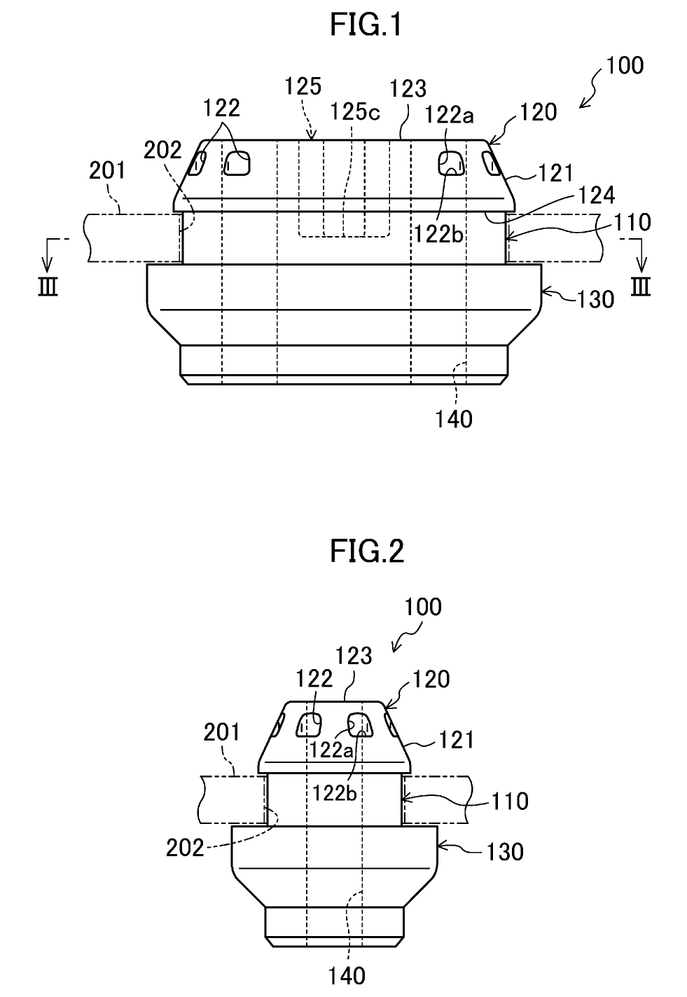

A grommet 100 for automotive vehicles is installed, for example, in a through hole 202 formed in a housing 201, as shown in FIGS. 1 and 2. While maintaining waterproofness of a circuit or another electrical device (not shown) connected to a cable (also not shown), the grommet 100 allows the cable to pass through. (Note that in FIGS. 1 and 2, for the sake of convenience, a gap between the grommet 100 and the housing 201 is drawn in an exaggerated manner.)

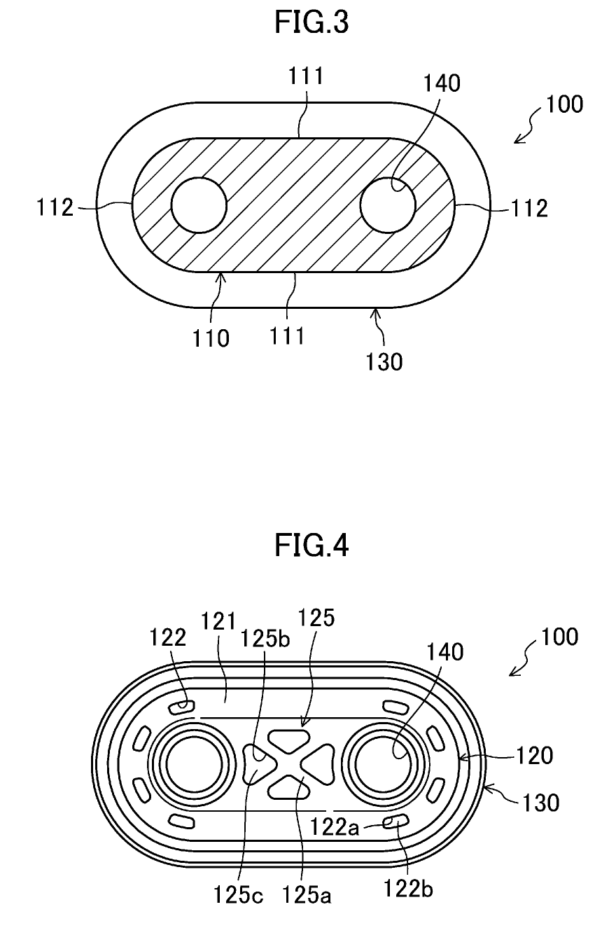

The grommet 100 includes a body 110 fitted into the through hole 202 of the housing 201, as well as an extension 120 and a flange 130 both having a shape larger in dimensions than the through hole 202 and formed so that the housing 201 is sandwiched from two sides. Two cable passing apertures 140, 140, through each of which one cable passes (FIGS. 3-5), are provided for the extension 120, the body 110, and the flange 130.

The body 110 of the grommet 100 has a cross-sectional shape corresponding to that of the through hole 202, i.e., a shape defined by a pair of parallel portions 111, 111 and circular arc-shaped portions 112, 112 on two sides, as shown in FIG. 3.

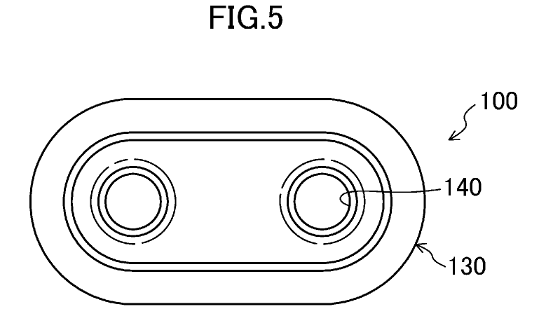

The extension 120 of the grommet 100 includes an inclined surface 121, an outer shape of which tapers toward an end 123 on a side opposite to the body 110. On a portion of the inclined surface 121 located between a body-near portion and an end-near portion, for example eight recesses 122, which are recessed with respect to the inclined surface 121, are formed. Each of these recesses 122 includes a vertical surface 122a, which is vertical with respect to a front face of the housing 201, and a parallel surface 122b, which is parallel to the front face of the housing 201. When viewed from a direction vertical to the front face of the housing 201, the recesses 122 are formed only on portions of the inclined surface 121 corresponding to the circular arc-shaped portions 112, 112 of the body 110, as shown in FIG. 4.

Further, a blind hole 125 is formed between the apertures 140, 140 at the end 123 of the extension 120. The blind hole 125 is divided by for example four ribs 125a into four triangular regions 125b. Moreover, the blind hole 125 has such a depth that its bottom is located near a body-near end 124 of the extension 120, concretely, for example, near the body 110 a few millimeters from the body-near end 124.

As described above, forming the recesses 122 on the inclined surface 121 of the extension 120 allows a part other than the recesses 122 to be easily reduced in size, and makes the grommet 100 easy to insert into the through hole 202 of the housing 201. Moreover, the recesses 122 are formed on a portion of the inclined surface 121 between the body-near portion and the end-near portion. In other words, in FIG. 1, a top end of each of the recesses 122 is located lower than the end 123 of the extension 120, and a bottom end of each of the recesses 122 is located higher than the body-near end 124. Therefore, a part of the end-near portion of the inclined surface 121 may be less likely to be caught in the through hole 202 when the grommet 100 is started to be inserted into the through hole 202. Further, stiffness near the body-near end 124 and near the end 123 of the extension 120 may be increased. Moreover, ensuring stiffness near the body-near end 124 may allow a body-near portion of the extension 120 to be pressed against a periphery of the through hole 202 of the housing 201 after the grommet 100 has been inserted into the through hole 202, and thus to easily increase waterproofness of the housing.

Furthermore, in comparison to the case where the grommet is formed in a complicated shape, as in Japanese Unexamined Patent Publication No. 2001-41359 or Japanese Unexamined Patent Publication No. 2015-15869, a mold to form the grommet 100 may be easily manufactured. Specifically, forming recesses 122 including the vertical surface 122a, which is vertical with respect to the front face of the housing 201, and the parallel surface 122b, which is parallel to the front face of the housing 201, may make the grommet 100 even easier to form, as compared to the case where the vertical surface 122a of the recesses 122 is inclined in the same manner as the inclined surface 121. Further, the extension 120 may be less likely to come off the through hole 202, as compared to the case where the recesses 122 are formed over an entire length between the end 123 and the body-near end 124 on the inclined surface 121. In the present disclosure, the terms “vertical” and “parallel” refer to substantial vertical and parallel dimensions including for instance the case where the vertical surface 122a and the parallel surface 122b have an inclination degree required to form the grommet 100.

Moreover, forming the recesses 122 only on a portion of the inclined surface 121 which corresponds to the circular arc-shaped portions 112, 112 of the body 110, may allow the grommet 100 to be reduced in size in a direction along the parallel portions 111, 111 of the body 110, and thus to be even easier inserted into the through hole 202 of the housing 201.

Further, forming a blind hole 125 on the end 123 of the extension 120 having a bottom 125c arranged at a lower location than the end face of the body-near end 124, makes the grommet 100 even easier to reduce in size, and thus easier to insert into the through hole 202 of the housing 201.

Moreover, forming the ribs 125a on the blind hole 125, which divide the same into the regions 125b, increases stiffness and thus may allow to easily increase waterproofness after the grommet has been inserted into the through-hole without impairing flexibility which has been increased due to the blind hole 125 and which allows the grommet to be easily inserted into the through-hole.

Furthermore, as in the above examples, vertices found opposite to bases of the triangles of the four blind holes and facing a center of the elliptical end 123 make it easy to reduce the extension 120 in size. Further, providing the above-described ribs 125a between the apertures 140, 140, may contribute to maintaining the strength of the surface of the end 123, while sufficiently maintaining an area required for the apertures 140, 140.

### Other Embodiments

In the above example in total eight recesses 122 are formed on the inclined surface 121 of the extension 120. However, note that the disclosure is not limited to this configuration and may be varied taking into consideration the size and degree of precision, material, ease of insertion, waterproofness and other features of the grommet 100.

Further, in the given example, the blind hole 125 formed on the end 123 of the extension 120 is divided by the ribs 125a into the four triangular regions 125b. However, the disclosure is not limited to this configuration. Instead, for example, ribs dividing the blind hole into four square-shaped regions arranged in a checked pattern may be provided. Alternatively, a blind hole having a five-sided or more sided outer shape may be provided with ribs arranged in a radial manner.

Moreover, the blind hole 125 (cf. FIG. 1) may have such a depth that the bottom 125c is arranged at a higher location than the body-near end 124 of the extension 120. However, provided that the blind hole 125 makes the grommet 100 both stiff and reducible, the bottom 125c may be located at any height.

Furthermore, the number of the apertures 140, 140 is not limited to two. One, three, or more than three apertures 140 may be provided.

What is claimed is:

1. A grommet interposed between (i) a housing having a through hole and (ii) a cable passing through the through hole, the grommet comprising:
a body fitted into the through hole of the housing; and
an extension located on one side of the housing with respect to the body and having a part larger in dimensions than the through hole of the housing, wherein
the extension has an inclined surface, an outer shape of which tapers toward an end on a side opposite to the body, and
a recess, which is recessed with respect to the inclined surface, is formed on a portion of the inclined surface between a body-near portion and an end-near portion.

2. The grommet of claim 1, wherein
the recess includes a surface vertical with respect to a front face of the housing and a surface parallel to the front face of the housing.

3. The grommet of claim 1, wherein
a cross-sectional shape of the body in a direction parallel to the front face of the housing is defined by a pair of parallel portions and circular arc-shaped portions on two sides, and the recess is only formed on a part of the inclined surface corresponding to the circular arc-shaped portions.

4. The grommet of claim 1, wherein
a blind hole, having a bottom arranged lower than an end face of the body-near end, is formed on an end of the extension on the side opposite to the body.

5. The grommet of claim 4, wherein
a rib is formed on the blind hole to divide the blind hole into regions.
